(19) United States
(12) Patent Application Publication
(10) Pub. No.: US 2018/0232708 A1
(43) Pub. Date: Aug. 16, 2018

(54) CONSUMER SERVICE PORTAL

(71) Applicant: Beacon Communications, LLC, Des Moines, IA (US)

(72) Inventor: Timothy P. Heady, Elkhart, IA (US)

(21) Appl. No.: 15/524,572

(22) PCT Filed: Nov. 4, 2015
(86) PCT No.: PCT/US15/59047

§ 371 Date: May 4, 2017

Related U.S. Application Data
(60) Provisional application No. 62/075,066, filed on Nov. 4, 2014.

(51) Int. Cl. G06Q 10/00; H04L 29/08; G06Q 30/00; G06Q 50/00

(52) U.S. Cl. CPC G06Q 10/20; G06Q 50/01; G06Q 30/01; H04L 67/20

(57) ABSTRACT

An improved method and system for generating and maintaining a business relationship is provided. The method includes providing a plurality of consumer communication tools. Each of consumer communication tools is a unique web-based business portal associated with a home repair service provider. The consumer communication tools are linked as a singular consumer service portal. The portal is configured to permit the home repair service providers of the consumer communication tools to interact directly with a consumer. The portal can be a consumer dashboard configured to receive consumer input or selections. A business dashboard can be operably linked to the consumer dashboard. A consumer profile can be customized by the consumer. The consumer can schedule an appointment with the home repair business, electrically sign documents, and research information of a scheduled home repair technician through the portal.

### CROSS-REFERENCE TO RELATED APPLICATIONS

This application claims priority to U.S. provisional application Ser. No. 62/075,066, filed Nov. 4, 2014, which is hereby incorporated by reference in its entirety.

### FIELD OF THE DISCLOSURE

The present disclosure relates generally to a web-based consumer service portal. More specifically, but not exclusively, the present disclosure relates to providing a web-based vehicle for linking consumers and home repair service providers for centralizing exchange of information and managing transactions.

### BACKGROUND OF THE DISCLOSURE

Consumers make hundreds to thousands of decisions and transactions with businesses per year, all of the experiences happening in a number of separate places such as store fronts, through business websites, or at the place of business of the consumer. Research on companies is done through internet searches, business web pages, business visits, and word of mouth conversations—all of which are scattered about. Even when a consumer has businesses that they prefer to work with and know whom they would like to do business they still have to go to all different individual places. Similarly, businesses have a desire to communicate specific information to a swath individual consumers from an informational, sales, marketing, and service standpoint, fitting each person's needs custom with the solutions offered. Therefore, there is a need resolve these and other deficiencies in the art.

### SUMMARY OF THE DISCLOSURE

One object of the present invention is to provide a web-hosted database of house projects that a consumer has installed or needs to install. A website allows consumers to find further information that is specific to each individual project and track the progress of projects, transactions, appointments, etc. Related objects and advantages of the present invention will be apparent to those of skill in the art.

According to an aspect of the present disclosure, a method of generating and maintaining a business relationship includes providing a plurality of consumer communication tools. Each of the plurality of consumer communication tools is a unique web-based business portal associated with one home repair service provider. The consumer communication tools are linked as a singular consumer service portal. The portal is configured to permit the home repair service providers of the plurality of consumer communication tools to interact directly with a consumer. A consumer profile can be customizable by the consumer. The consumer can select one or more of the consumer communication tools is associated with the customizable consumer profile. The selected consumer communication tools can be customizable by the home repair service provider after selection by the consumer. The method can further include the step of providing notifications from the plurality of consumer communication tools to the consumer, permitting the consumer to share experiences on social media and/or permitting the consumer to provide feedback to the business via the singular consumer service portal.

According to another aspect of the present disclosure, a method of generating and maintaining a business relationship is provided. A web-based portal is divided into a consumer side and a business side. The consumer side is administered by a consumer and comprises a customizable consumer profile, and a plurality of consumer communication tools. Each of the plurality of consumer communication tools associated with a home repair service provide. The business side is administered by the home repair service provider and comprises a customizable business profile, and project tracking tools. The consumer side and the business side are interfaced so as to select one or more home repair service providers of the consumer communication tools and organize the selected home repair service providers on the consumer side of the portal. The portal permits the home repair service providers and the consumer to interact directly.

The method can further include the step of permitting a business to invite consumers to add the home repair business to a consumer page. The home repair business can be charged a fee for each of the invited consumers that elects to add the home repair business to the consumer page. The home repair business can pre-mail the consumer with information about products or services of the home repair business. Through the portal, the consumer can schedule an appointment with the home repair business, electrically sign documents, and/or receive information of a scheduled home repair technician.

According to yet another aspect of the present disclosure, a web-based system for generating and maintaining a business relationship between a home repair service provider and a consumer is provided. A consumer dashboard is configured to receive consumer input or selections. The consumer interact is comprised of a plurality of individualized consumer portals. A business dashboard is operably linked to the consumer dashboard and configured to receive home repair service provider input or selections. The business dashboard is comprised of a plurality of home repair service providers. The consumer input or selections includes a selected combination of one or more of the plurality home repair service providers. The consumer dashboard can be configured to organize upcoming appointments for the consumer.

### BRIEF DESCRIPTION OF THE DRAWINGS

FIG. 1 is an exemplary feature of an exemplary embodiment of the present disclosure;

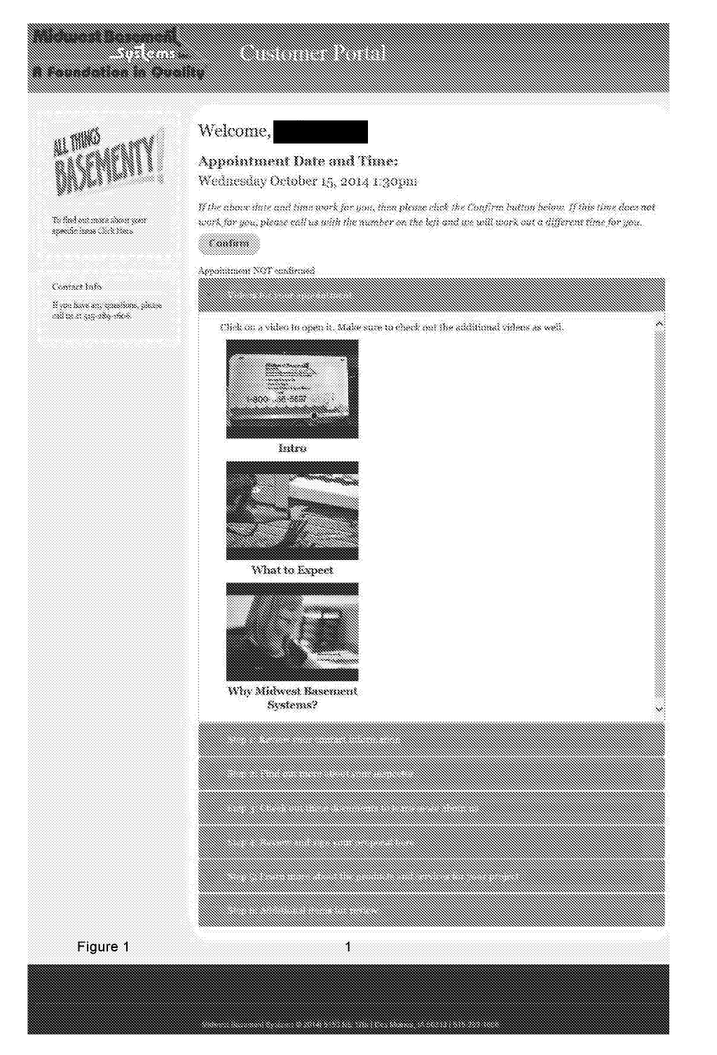

FIG. 2 is an exemplary feature of an exemplary embodiment of the present disclosure;

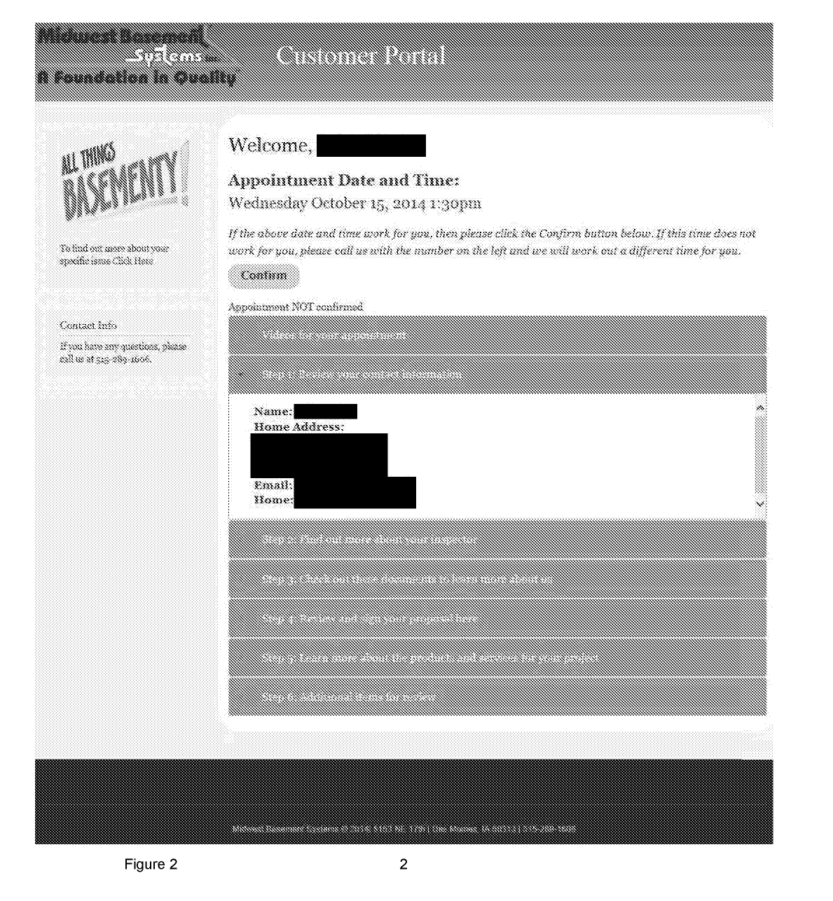

FIG. 3 is an exemplary feature of an exemplary embodiment of the present disclosure;

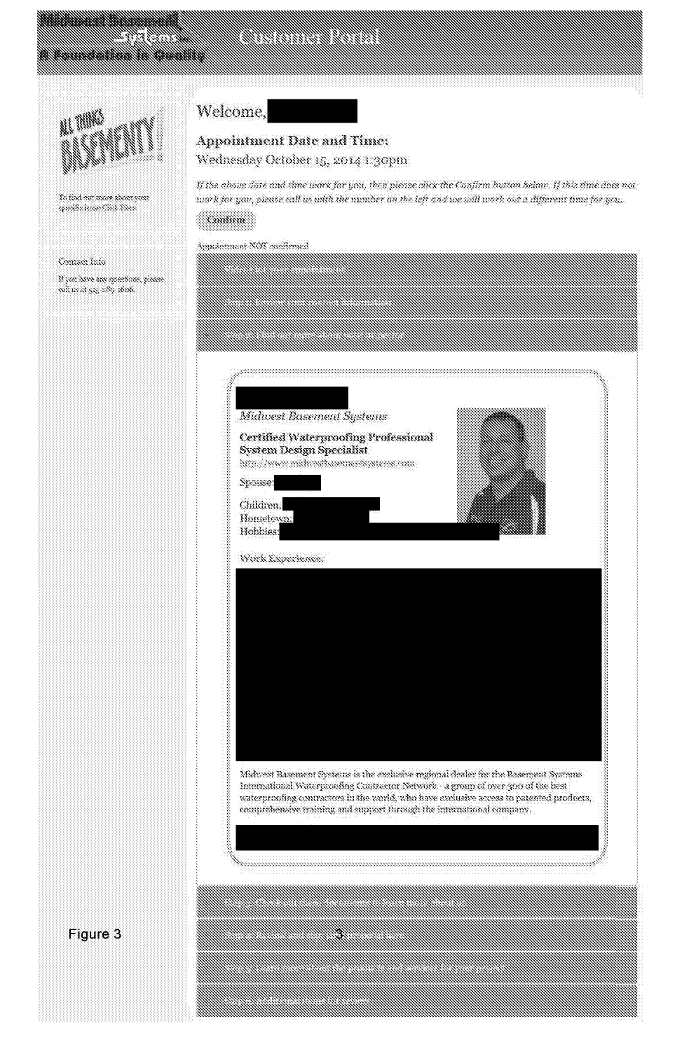

FIG. 4 is an exemplary feature of an exemplary embodiment of the present disclosure;

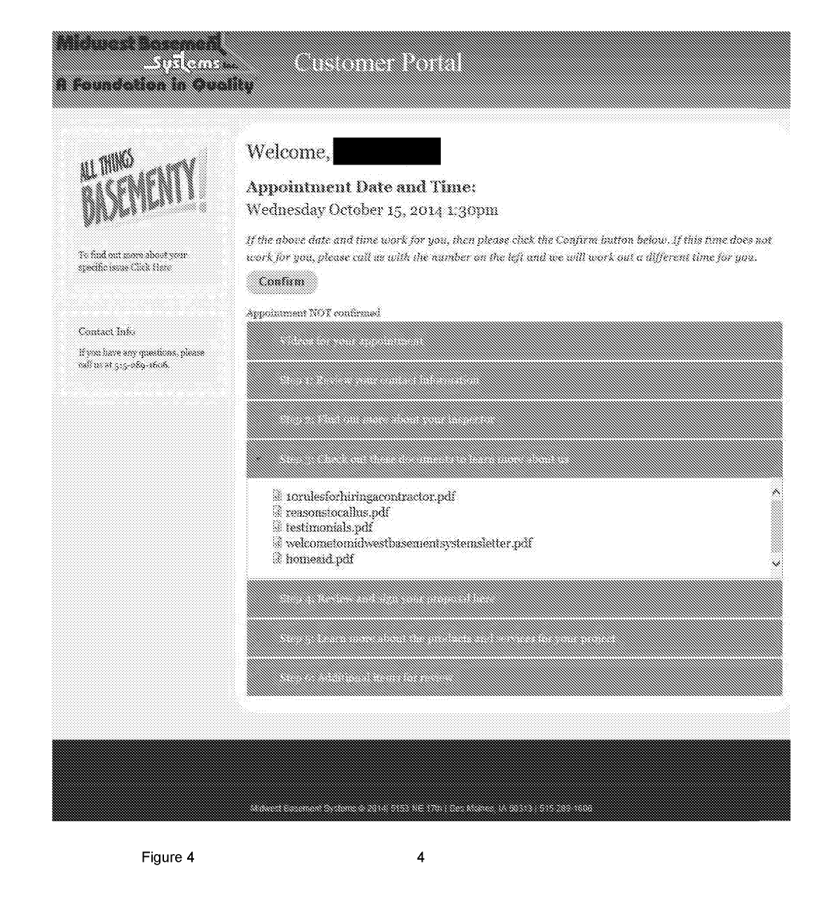

FIG. 5 is an exemplary feature of an exemplary embodiment of the present disclosure;

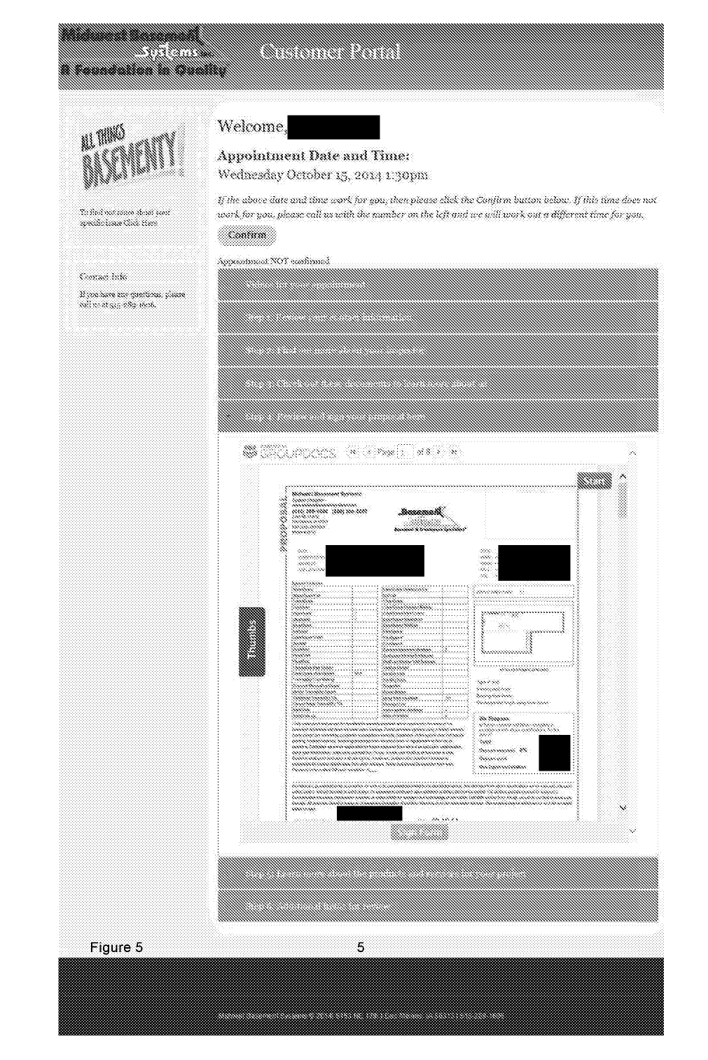

FIG. 6 is an exemplary feature of an exemplary embodiment of the present disclosure;

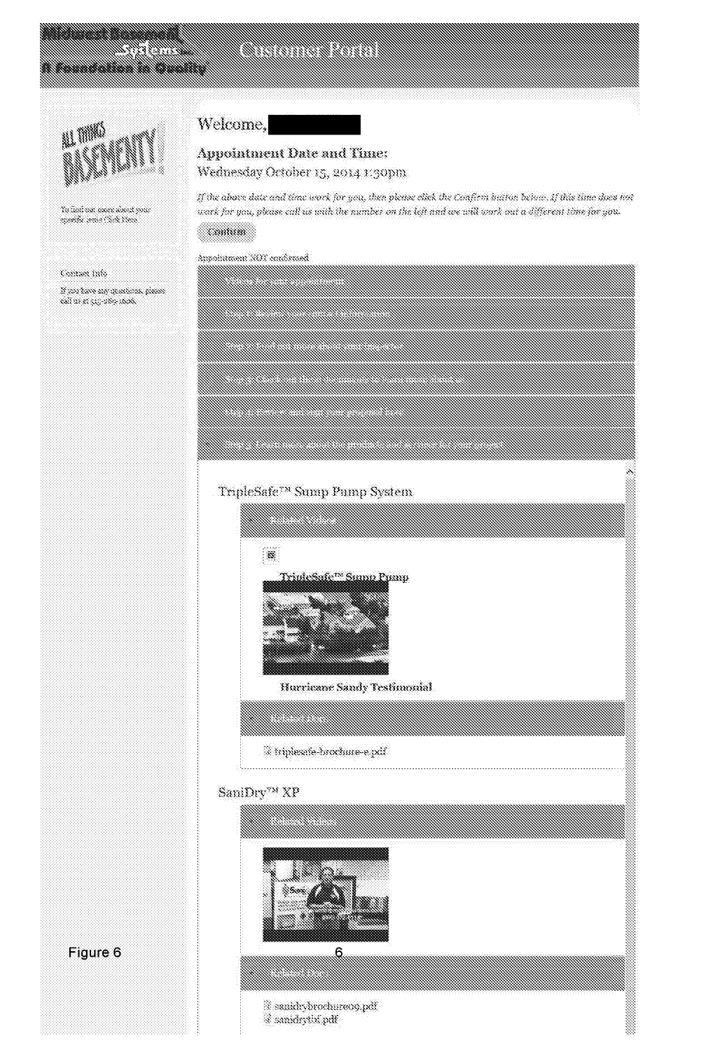

FIG. 7 is an exemplary feature of an exemplary embodiment of the present disclosure;

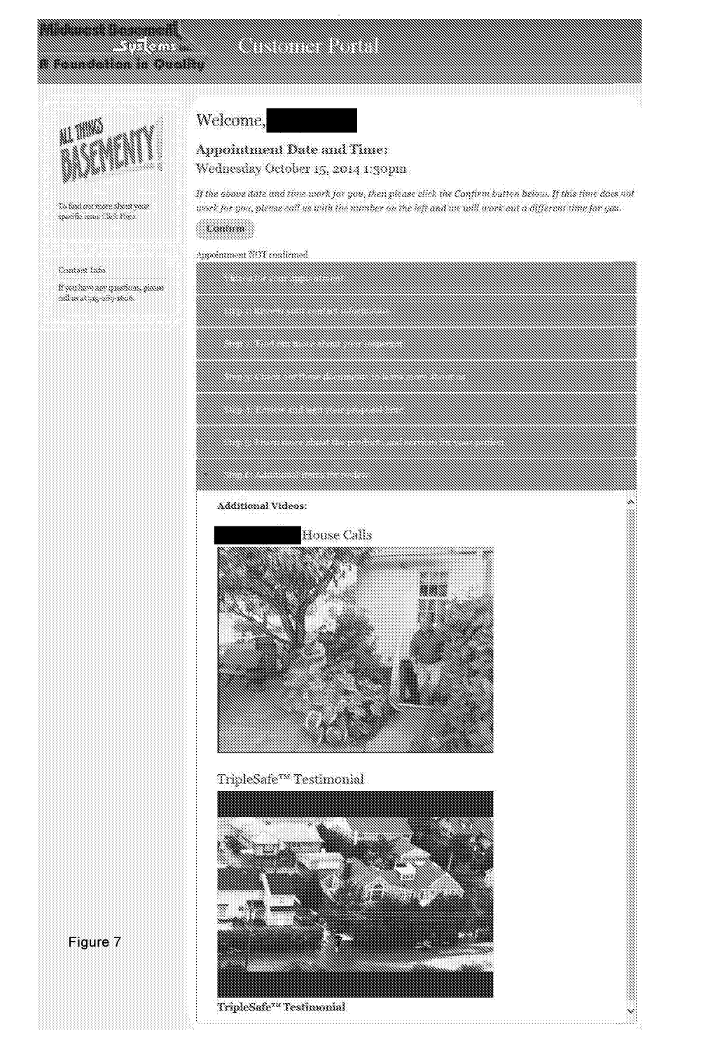

FIG. 8 is an exemplary feature of an exemplary embodiment of the present disclosure; and

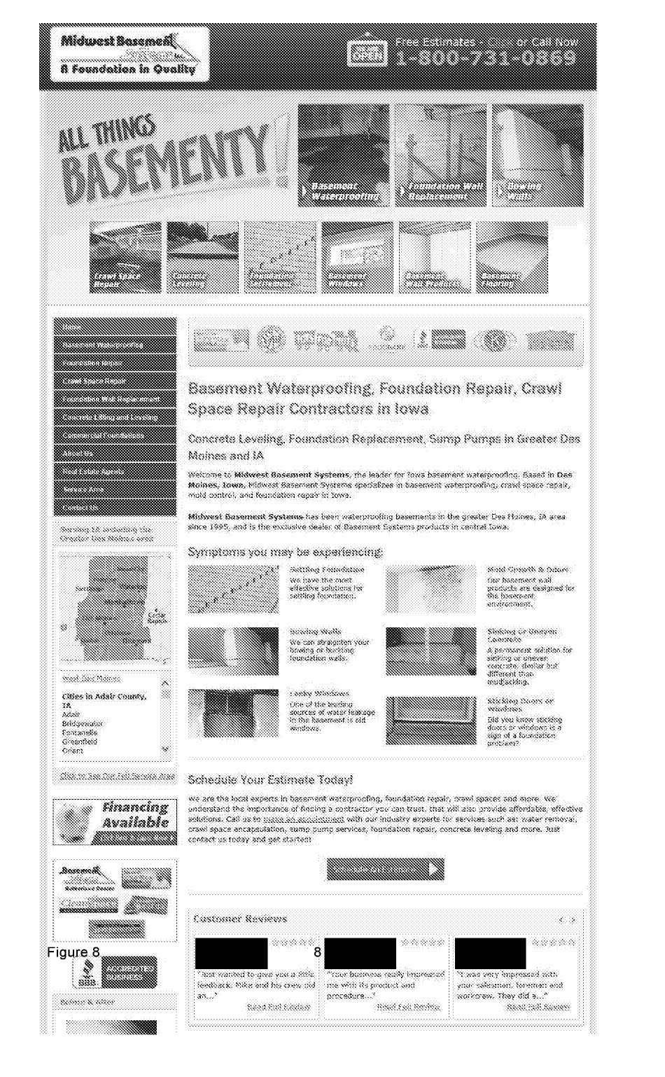

FIG. 9 is an exemplary feature of an exemplary embodiment of the present disclosure.

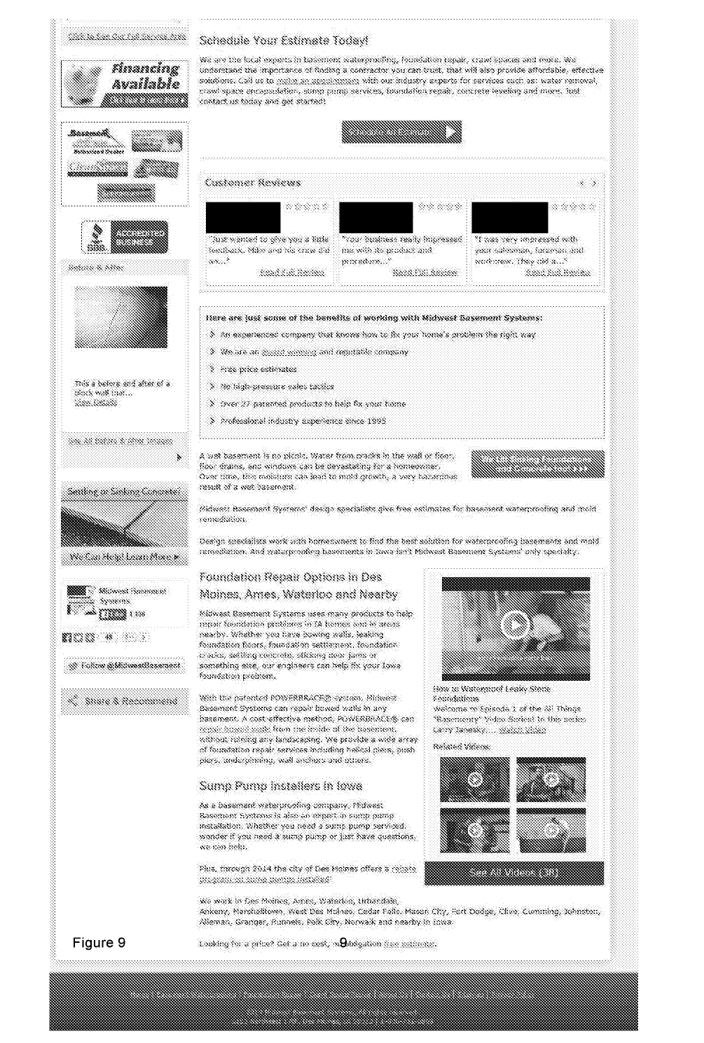

### DETAILED DESCRIPTION OF THE PREFERRED EMBODIMENTS

The present invention relates to a process of tracking house projects that a consumer has installed or needs to install using a web-hosted database. This web-hosted database allows consumers to link to each of their consumer communication tools (individualized websites). Thus allowing consumers to find further information that is specific to each individual interaction with each business and track the progress of projects, transactions, appointments, etc. From the business angle it serves not only as a transaction tool but also as a marketing tool with the capability to give consumers a customized experience through individually designated sites and, allow the opportunity to relay more of the company's business practices and what the consumer experience will involve. This tool would allow a consumer to keep all of the businesses in one location (a web site) and to communicate with each business through their consumer communication portal, web sites unique to each business with individual profiles for each consumer.

The consumer experience with the site is for the lifetime of the business relationship with each company. It takes the consumer from their first contact with the business, gaining more knowledge on the company, information pertinent to the consumer's needs, through the transaction process, and finally to follow up marketing information on other products or services they may be interested in. Each business' site will be a little different to best suit the consumer interaction that fits the industry they work within.

The consumer would be able to control their profile and which businesses appear within it. Consumers can delete them or send notifications to businesses that they would like to add to their profile.

The Consumer Side Process:
In order to use the business housing database site a consumer would have to create an account/profile signing up like you would on many other sites (Facebook, LinkedIn, Amazon, etc.).
Once an account is created (including an email address, login, and password) a profile will be created by the consumer with basic information (address, phone, email, age, sex, marital status). Some of this information may be optional.
The basic information will allow businesses to setup personalized sites for each consumer once a consumer has decided they would like to include that business on their business database.
After the profile setup is complete, the consumer will have an empty homepage that they can now begin to add businesses to.
A search query will be available to search for businesses by geographical area, industry/products, or specific business name. This will allow a consumer to begin adding businesses they would like to have on their page.
All businesses added to the consumer's page would be accessible through links in the form of buttons, taking them to their individualized consumer portals for the specific businesses.
The consumer will receive notifications of updates to their portals for each business on their profile, allowing consumers to check for any new information each business has for them (contracts, videos, product offerings, maintenance information etc.).
A social share capability will allow consumers to share their experiences with different businesses with friends on different social media.
A feedback function will also allow reporting on business practices of the businesses on the site to create business reviews and ratings for other users of the site to view.
A social feature including Facebook or other social media sites will be incorporated to allow communication with the site to see what experiences with particular businesses are like.
Expenditure tracking for consumers to see how much, where and with whom they have spent their money in graph or spreadsheet form may be included.
Project tracking for work done by a consumer and not a company that tracks budget, expenses, products needed, status, and DIY tips may be another feature.

### The Business-Side Overview:

This site will allow businesses to set up consumers with individualized pages that are only accessible by that consumer, allowing you to communicate a message to one consumer or to all of them. This gives the business a multitude of capabilities including sharing company/product/service information, sales and transactions, direct communication, marketing, future service, etc.

This site will also give businesses a chance to be searchable to consumers in their service area via the site that may not have known about them previously. When a business signs up they are included in the database of businesses that consumers can search through using different criteria including geographical area, industry, reviews, etc. via the sites search query function. In addition to being searchable they may also advertise on the site to specific audiences through run of site ads for an additional fee. This is one of the monetization pieces of the site.

Businesses will also have the ability to send out invitations to current consumers as well as potential consumers that are interested in them via other avenues and are not already using the site. These invitations will assist the consumer in setting up an account and then include the business on the consumers profile once the account is created.

### The Business-Side Process:

In order for a business to be accessible on the site they must sign up for a customizable consumer communication site allowing them to create personalized portals for each of their consumers.
A business will be able to sign up via a web form similarly to an account creation of a consumer but more in depth and requiring payment information. They may also call to have their account created.
Once an account has been created the business will receive a blank template site that will give instruction on how to customize their site with logo, video, brochures, color, text, images, etc. Or they may have a site designed for them at an additional charge.
Once a business has their site set up to their liking they will be added to the data base of searchable businesses and may now begin to use their consumer communication site with their clientele.
A charge of $5 per consumer added to the consumer communication site will be assessed and is the primary monetization function of the site. This is a one-time fee for each consumer and will be billed periodically.
Businesses are not only searchable via the site by consumers in their geographical area but they also have the option of advertising to target consumers that they believe would need their business.
Any consumer that adds this business will be automatically set up with a consumer portal for that business and the business will be notified that the consumer is interested in their product or services.
Any consumer the business creates a site for will be notified to add them to their profile or walk them through creating an account if they have not already done so. A link may be provided on their profile to then access their customized portal for that specific business.

### The Individualized Sites or Consumer Portals:

A web application marketing tool to provide a personalized experience for potential and existing consumers that will educate them on the products and services that companies have to offer. It serves as a two-way consumer communication tool that promotes a lifetime conversation with the consumer. It allows companies to customize marketing, sales, service and product information they'd like to relay to their consumers via personalized web pages. The portals provide a user experience for potential clients that guide consumers through the consumer process, from the time a client calls all the way through the life of the project.

Functionality from the Consumer-Side:

Potential consumers log in to the consumer communication tool via the links to businesses in their www.bizstash.com profile, manually with a unique ID, or via automated email to obtain information about the company's products and services along with personalized details.

Consumers are able to access information the company would like to convey about themselves prior to the first live interaction via videos, brochures and other media in what we call the pre-appointment or pre-mailer section.

Consumers are able to view details about potential appointments, including when the appointment will occur, where it is set to take place and personal contact information to verify.

Consumers are able to view information about their primary contact (sales, consumer service rep) that they will be working with to familiarize them with the individual before they interact with them in an appointment or conversation.

Consumers receive reminder text messages to their designated phone number with appointment information.

Consumers have the capability to E-sign documents, contracts, proposals etc. via third party software.

Consumers are informed of post-sale information that may pertain to their project/product/service purchase via their consumer portal notifications. ¬

Consumers are eligible to receive marketing information that a business believes may interest them including specials, new product/service offerings, company changes, etc.

Functionality from the Business Side:

Accessing the backend of the site to modify what the end user or consumer sees is done through the homepage web address mwbs.info and then add “/user”. This will bring up a login page where account holders will have the ability to log in and make edits or add new consumers.

Businesses have access to several different user types with different levels of penetration. These levels may be different for every business and can be modified to allow different capabilities of each account. A Call Center, System Designer, and Admin account may be used. These three user levels have different capabilities to control what each employee can do and to simplify their account to make their job easier.

A call center account will allow designated people to set up and modify appointments for potential clients. They can add consumers but may not delete them or any other content within the system. They may edit consumer information but only carry access to the pre-appointment editing capabilities. This is the lowest level of access.

A system designer account carries the same capabilities as the call center but in addition is capable of editing a consumer's post-appointment information including uploading and editing contracts in the consumer portal. From the edit function a business will be able to modify what company services a consumer can view. This account type still does not have the capabilities to delete consumers or any site content.

Those rights are reserved for an admin account that carries all the aforementioned capabilities as well as the ability to add and delete content within the site. That includes consumer deleting, adding or deleting other user types, data analysis for the site, and changes to the site layout and functionality.

The dashboard is a location in the site that allows for organization and search of consumers that have been entered. It is sortable by any fields included in the consumer setup (Name, appointment date, sales rep, address, etc.). This allows users to quickly search for consumers to view or edit via a search query of all the information listed previously. The dashboard also allows for quickly getting information like when the profile was last accessed, if a person has confirmed their appointment and other valuable information at a quick glance as opposed to digging through each profile.

Businesses have the ability to create a consumer by using a unique ID that they can give to each of them creating a personalized URL for all consumers. They may also capture other consumer information relevant to their business relationship such as name, address, email, phone etc.

A data analysis of people using the site and how they are using it is accessible to administrators to monitor the sites effectiveness. It allows for seeing what percentage are logging in, confirming appointments, how often they look at it and when it was most recently checked.

Businesses are able to upload a proposal/contract or any document they would like to give the consumer the ability to sign, to a consumer's profile with E-Signature capability through third party software. All signatures are verified via the third party software and are a binding agreement.

Businesses have the capability to brand the sight according to their message and look. The template is easily editable with blocks for logos, links, images etc. They can also upload their own personalized content that goes out to consumers at different phases of the consumer interaction. Videos, PDF's, images, a multitude of file types can be uploaded to grant access to each individual consumer as they see fit.

### Features/Potential Features

The application is accessible from any device with internet access.
Capable of playing videos, displaying images, uploading files, displaying pdfs.
The application comes optimized for integrated third party Contract Management Software for electronic document signing (allows consumer to electronically sign their proposal).
All consumer pages are web hosted with unique URLs.
Integrate the site with any ERP “Enterprise Resource Planning” system (bizWiz, goldmine, QuickBooks, etc.).
The application sends consumers an email to notify them of any changes or updates that have been made to their account.
Notify consumer what fields were changed in account and include in update email.
Send consumer SMS (text) message to remind consumer of their appointment.
Include section on consumer's portal to inform consumer of any post-sale-information they may be interested in.
Set up survey to be taken on site to determine status of consumer's issue in “Follow-up” step.
Type service message or product update and send to consumer.
Include operations on the Dashboard to allow editing user account, editing property/properties for selected consumers.
Ability to archive a job to remove from appointments that are yet to be run.
Archiving designates that a job is complete and that it is to be moved to a separate Dashboard for a different job status.
The application includes multiple dashboards to compartmentalize consumers for-contact purposes (i.e. existing, potential, does not contact, etc.).
Set up section to be used for service appointments, to include pre job inspector profile and appointment date/time.
Allow data about consumers to be exported to Excel spreadsheet

The present invention relates in general to a consumer service portal and process of tracking housing projects. The present invention is described as it applies to its preferred embodiment. It is not intended that the present invention be limited to the described embodiment. It is intended that the invention cover all modifications and alternatives, which may be included within the spirit and scope of the invention. A general description of the present invention as well as a preferred embodiment to the present invention has been set forth. Those skilled in the art to which the present invention pertains will recognize and be able to practice additional variations in the method and systems described which fall within the teachings of this invention. Accordingly, all such modifications and additions are deemed to be within the scope of the invention which is to be limited only by the issued claims.

What is claimed is:

1. A method of generating and maintaining a business relationship, the method comprising the steps of:
providing a plurality of consumer communication tools, wherein each of the plurality of consumer communication tools is a unique web-based business portal associated with one home repair service provider;
linking the plurality of consumer communication tools as a singular consumer service portal; and
wherein the singular consumer service portal is configured to permit the home repair service providers of the plurality of consumer communication tools to interact directly with a consumer.

2. The method of claim 1, further comprising the step of providing a consumer profile customizable by the consumer.

3. The method of claim 2, wherein the consumer selects one or more of the plurality of consumer communication tools is associated with the customizable consumer profile.

4. The method of claim 3, wherein the selected one or more of the plurality of consumer communication tools is customizable by the home repair service provider after selection by the consumer.

5. The method of claim 4, further comprising the step of providing notifications from the plurality of consumer communication tools to the consumer.

6. The method of claim 5, further comprising the step of permitting the consumer to share experiences on social media.

7. The method of claim 5, further comprising the step of permitting the consumer to provide feedback to the business via the singular consumer service portal.

8. The method of claim 5, further comprising the step of permitting the consumer to rate the business via the singular consumer service portal.

9. A method of generating and maintaining a business relationship, the method comprising the steps of:
dividing a web-based portal into a consumer side and a business side, wherein the consumer side is administered by a consumer and comprising:
(a) a customizable consumer profile; and
(b) a plurality of consumer communication tools, wherein each of the plurality of consumer communication tools associated with a home repair service provider;
wherein the business side is administered by the home repair service provider and comprising:
(a) a customizable business profile; and
(b) project tracking tools;
interfacing the consumer side and the business side so as to select one or more home repair service providers of the plurality of consumer communication tools and organize the selected home repair service providers on the consumer side of the web-based portal.

10. The method of claim 9, wherein web-based portal permits the home repair service providers and the consumer to interact directly.

11. The method of claim 10, further comprising the step of permitting a business to invite consumers to add the home repair business to a consumer page.

12. The method of claim 11, further comprising the step of charging the home repair business a fee for each of the invited consumers that elects to add the home repair business to the consumer page.

13. The method of claim 12, further comprising the step of the home repair business pre-mailing the consumer with information about products or services of the home repair business.

14. The method of claim 13, further comprising the step of the consumer scheduling an appointment with the home repair business through the web-based portal.

15. The method of claim 14, further comprising the step of the consumer electrically signing documents through the web-based portal.

16. The method of claim 16, further comprising the step of posting information of a scheduled home repair technician through the web-based portal.

17. A web-based system for generating and maintaining a business relationship between a home repair service provider and a consumer, the system comprising:
a consumer dashboard configured to receive consumer input or selections, wherein the consumer interact is comprised of a plurality of individualized consumer portals;
a business dashboard operably linked to the consumer dashboard and configured to receive home repair service provider input or selections, wherein the business dashboard is comprised of a plurality of home repair service providers; and
wherein the consumer input or selections includes a selected combination of one or more of the plurality home repair service providers.

18. The system of claim 17, wherein the consumer dashboard permits the consumer to perform at least two of:
(a) rate one of the plurality of home repair service providers;
(b) provide feedback to the one of the plurality of home repair service providers; and
(c) share experiences on a social media outlet.

19. The system of claim 17, wherein the consumer dashboard is configured to organize upcoming appointments for the consumer.
